(19) United States
(12) Patent Application Publication
(10) Pub. No.: US 2025/0095332 A1
(43) Pub. Date: Mar. 20, 2025

(54) METHOD AND APPARATUS FOR VIDEO PROCESSING, DEVICE, AND MEDIUM

(71) Applicant: Beijing Zitiao Network Technology Co., Ltd., Beijing (CN)

(72) Inventors: Guangde HUANG, Beijing (CN); Zhanpeng HUANG, Beijing (CN); Xuyue HAN, Beijing (CN); Ting LUO, Beijing (CN); Yihan YANG, Beijing (CN)

(21) Appl. No.: 18/577,081

(22) PCT Filed: Sep. 22, 2023
(86) PCT No.: PCT/CN2023/120590

§ 371 Date: Jan. 5, 2024

(30) Foreign Application Priority Data
Sep. 23, 2022 (CN) 202211168270.4

(51) Int. Cl. G06V 10/75

(52) U.S. Cl. CPC G06V 10/751

(57) ABSTRACT

Embodiments of the present disclosure provide a method and apparatus for video processing, a device, and a medium, the method includes: distributing first shoot frames to a recording unit and a content analysis unit during a shooting process; performing a recording processing on the first shoot frames by the recording unit to obtain a recorded video; and performing a content analysis processing on the first shoot frames by the content analysis unit to obtain content analysis results of the first shoot frames; in case of obtaining the recorded video, determining a content analysis result of the recorded video based on the content analysis results of the first shoot frames; the content analysis result of the recorded video is used when performing an edit processing on the recorded video.

### CROSS-REFERENCE TO RELATED APPLICATION

The present application claims priority of the Chinese Patent Application No. 202211168270.4 filed on Sep. 23, 2022, the entire disclosure of which is incorporated herein by reference as part of the present disclosure.

### TECHNICAL FIELD

Embodiments of the present disclosure relate to a method and apparatus for video processing, a device, and a medium.

### BACKGROUND

In some video clipping software, after the user shoots to obtain a recorded video and stores the recorded video in an album, the content analysis is performed on the recorded video selected by the user from the album, so that the recorded video can be automatically edited (also called clipping) based on the content analysis result, and presents the edited video to the user. However, the inventor found through research that the above method is cumbersome and the content analysis takes a long time. As a result, the user usually needs to wait for a long time to see the final edited video, resulting in a poor user experience.

### SUMMARY

In order to solve the above technical problems or at least partially solve the above technical problems, the present disclosure provides a method and apparatus for video processing, a device, and a medium.

Embodiments of the present disclosure provide a method for video processing, which includes: distributing first shoot frames to a recording unit and a content analysis unit during a shooting process: performing a recording processing on the first shoot frames by the recording unit to obtain a recorded video; and performing a content analysis processing on the first shoot frames by the content analysis unit to obtain content analysis results of the first shoot frames: in case of obtaining the recorded video, determining a content analysis result of the recorded video based on the content analysis results of the first shoot frames, the content analysis result of the recorded video is used to perform an edit processing on the recorded video.

Optionally, distributing the first shoot frames to the recording unit and the content analysis unit during the shooting process includes: in case of reaching a specified condition, distributing the first shoot frames to the recording unit and the content analysis unit during the shooting process.

Optionally, the specified condition includes a specified control on a shooting interface being triggered.

Optionally, performing the content analysis processing on the first shoot frames includes: inputting the first shoot frames to a content recognition model, which is preset, to perform a recognition processing on screen contents of the first shoot frames by the content recognition model.

Optionally, determining the content analysis result of the recorded video based on the content analysis results of the first shoot frames includes: performing statistics based on the content analysis result of each of the first shoot frames to determine a type of a shot subject of the recorded video; and obtaining the content analysis result of the recorded video based on the type of the shot subject of the recorded video.

Optionally, performing statistics based on the content analysis result of each of the first shoot frames to determine the type of the shot subject of the recorded video includes: counting a frequency of appearance of a shot object of each specified type in all of the first shoot frames: determining the type of the shot subject of the recorded video based on the frequency of appearance of the shot object of each specified type.

Optionally, the first shoot frames are each of all shoot frames obtained during the shooting process, or the first shoot frames are shoot frames extracted at a specified interval during the shooting process.

Optionally, the recorded video further includes a second shoot frame, the second shoot frame is a video frame image which is not involved in the content analysis processing.

Optionally, the method further includes: obtaining a matching clip template of the recorded video based on the content analysis result of the recorded video: performing the edit processing on the recorded video through the matching clip template to obtain a target video.

Optionally, the method further includes: displaying template identifiers of a plurality of candidate clip templates together with the target video on a display page: in response to monitoring that a user selects a template identifier of a target clip template from the template identifiers of the plurality of candidate clip templates, performing the edit processing on the recorded video through the target clip template to obtain a formulated video; replacing the target video on the display page with the formulated video.

Optionally, the method further includes: saving the recorded video by default, and/or, saving the target video upon receiving a save instruction issued by the user for the target video.

Embodiments of the present disclosure further provide an apparatus for video processing, which includes: a shoot frame distribution module configured to distribute first shoot frames to a recording unit and a content analysis unit during a shooting process: a shoot frame processing module configured to perform a recording processing on the first shoot frames by the recording unit to obtain a recorded video; and perform a content analysis processing on the first shoot frames by the content analysis unit to obtain content analysis results of the first shoot frames: a video processing module configured to determine a content analysis result of the recorded video based on the content analysis results of the first shoot frames in case of obtaining the recorded video, the content analysis result of the recorded video is used to perform an edit processing on the recorded video.

Embodiments of the present disclosure further provide an electronic device, which includes a processor: a memory used to store an executable instruction that can be executed by the processor: the processor is configured to read the executable instruction from the memory and executes the executable instruction to implement the method for video processing provided by embodiments of the present disclosure.

Embodiments of the present disclosure further provide a computer-readable storage medium, the computer-readable storage medium stores a computer program, and the computer program is used to perform the method for video processing provided by embodiments of the present disclosure.

Embodiments of the present disclosure further provide a computer program product, which includes a computer program, the computer program upon execution by a processor, implements the method for video processing provided by embodiments of the present disclosure.

It should be understood that what is described in this section is not intended to identify key or important features of embodiments of the present disclosure, nor is it intended to limit the scope of the present disclosure. Other features of the present disclosure will be readily understood by the following description.

### BRIEF DESCRIPTION OF THE DRAWINGS

The drawings herein are incorporated into and form a part of the specification, illustrate embodiments consistent with the present disclosure, and are used in conjunction with the specification to explain the principles of the present disclosure.

To more clearly illustrate the embodiments of the present disclosure, the drawings required to be used for the embodiments are briefly described in the following, obviously, for those skilled in the art, other drawings can be acquired based on these drawings without any inventive work.

FIG. 1 is a schematic diagram of an implementation flowchart of a one-click video-making function provided by the related art;

FIG. 2 is a schematic flowchart of a method for video processing provided by an embodiment of the present disclosure:

FIG. 3 is a schematic flowchart of a method for video processing provided by an embodiment of the present disclosure:

FIG. 4 is a schematic flowchart of a video processing flow provided by an embodiment of the present disclosure;

FIG. 5 is a structural schematic diagram of an apparatus for video processing provided by an embodiment of the present disclosure; and

FIG. 6 is a structural schematic diagram of an electronic device provided by an embodiment of the present disclosure.

### DETAILED DESCRIPTION

In order to understand the above objects, features, and advantages of the present disclosure more clearly, the solutions of the present disclosure are further described below. It should be noted that embodiments and features in the embodiments of the present disclosure may be combined with each other without conflict.

Many specific details are set forth in the following description to facilitate a full understanding of the present disclosure, but the present disclosure may also be implemented in other ways different from those described herein: obviously, the embodiments in the specification are only a part but not all of the embodiments of the present disclosure.

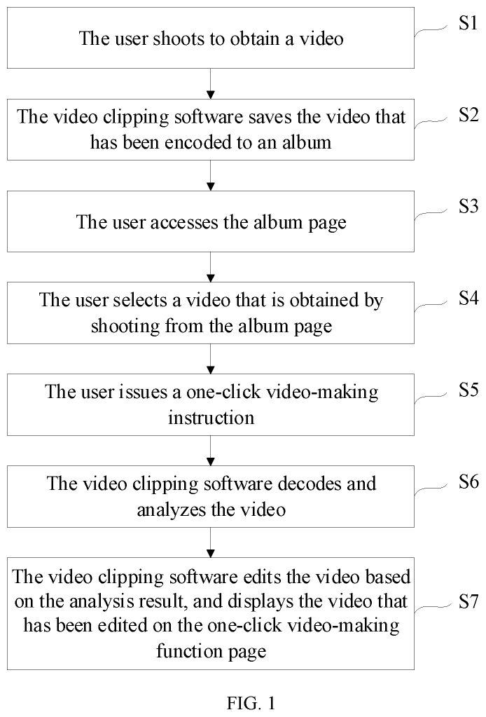

As people's demand for video clipping gradually increases, in order to enhance the convenient and interest of video clipping, the video clipping software has launched a one-click video-making function for the user. Specifically, the user needs to select the shot video from the album, the video clipping software performs content analysis on the recorded video, automatically clips the recorded video based on the content analysis result, and directly presents the clipped video to the user. However, this method is time-consuming and the process is redundant and complex. For details, please refer to the schematic flowchart of an implementation flowchart of a one-click video-making function provided by the related art as illustrated in FIG. 1, which briefly outlines the following core steps:
Step S1: The user shoots to obtain a video. For example, the user may shoot to obtain the video using the shooting function in the video clipping software.
Step S2: The video clipping software saves the video that has been encoded to an album.
Step S3: The user accesses the album page.
Step S4: The user selects a video that is obtained by shooting from the album page.
Step S5: The user issues a one-click video-making instruction.
Step S6: The video clipping software decodes and analyzes the video.
Step S7: The video clipping software edits the video based on the analysis result, and displays the video that has been edited on the one-click video-making function page.

The inventor found through research that the material analysis process in the above process is very time-consuming. It is necessary to first decode the video stored in the album, and then perform algorithmic analysis on the picture content in the decoded video, which takes a long time. Especially for the video, the time consumed by the above-mentioned material analysis process may occupy one-third or more of the overall duration of the video, and the user needs to wait for a long time before watching the finished video. In addition, the implementation link of the above one-click video-making function is relatively long, requiring the user to first shoot the video, and then encode the video and store it in the album. After the user sends a one-click video-making instruction, the encoded video is then taken out of the album and is decoded and analyzed. The above process is complicated and lengthy, not only does it take a long time for the user to see the finished video, but also the interaction experience of the user using the one-click video-making function is not good, and the user needs to perform more complicated operations to achieve it.

The above defects in the related art are the result obtained by the inventor after practice and careful study, and therefore, the process of discovery of the above defects and the solutions proposed by the embodiments of the present disclosure for the above defects below are recognized as the inventor's contribution to the present disclosure. In order to at least partially ameliorate the above problems, the embodiments of the present disclosure provide a method and apparatus for video processing, a device, and a medium, which are described in detail below:

The technical solution provided by embodiments of the present disclosure can distribute first shoot frames to a recording unit and a content analysis unit during the shooting process: perform a recording processing on the first shoot frames by the recording unit to obtain a recorded video; and perform a content analysis processing on the first shoot frames by the content analysis unit to obtain the content analysis results of the first shoot frames: in case of obtaining the recorded video, determine the content analysis result of the recorded video based on the content analysis results of the first shoot frames: the content analysis result of the recorded video is used to perform an edit processing on the recorded video. The above method can directly perform recording and content analysis on the shoot frame at the same time during the shooting process, that is, the shooting process and the content analysis process are in parallel, so that the content analysis result can be obtained faster, the efficiency of editing the recorded video based on the content analysis result can be further improved. This not only effectively shortens the waiting time before the user watches the edited video, but also the overall process is simple, without requiring the user to perform complicated operations, thus comprehensively improving the user experience.

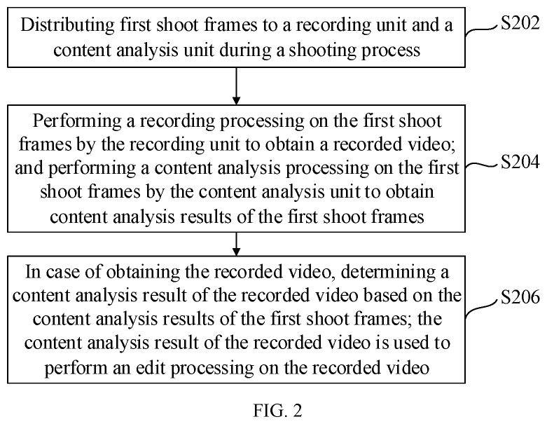

FIG. 2 is a schematic flowchart of a method for video processing provided by an embodiment of the present disclosure, the method may be performed by an apparatus for video processing, the apparatus may be implemented using software and/or hardware, and may generally be integrated in an electronic device. As illustrated in FIG. 2, the method mainly includes the following steps S202˜S206.
Step S202, distributing first shoot frames to a recording unit and a content analysis unit during a shooting process.

In the practical application, the first shoot frame may be an image frame collected by the electronic device through a camera: the first shoot frame may be each of all shoot frames obtained during the shooting process, or the first shoot frame may be the shoot frame extracted at a specified interval during the shooting process. For example, taking equal interval extraction as an example, the first frame, the N-th frame, the (2N)-th frame, the (3N)-th frame, . . . are used as the first shoot frames, and N can be selected according to the demand. The specific setting can be flexibly set according to the actual demand, which is not limited herein.

Both the recording unit and the content analysis unit mentioned above may be composed of software/hardware and have corresponding functions. The recording unit and the content analysis unit can also be understood as two functional modules. For the recording unit, the recording unit has a recording function, which can be used to perform a recording task to obtain a recorded video based on the acquired shoot frames. For the content analysis unit, the content analysis unit has a content analysis function, which can be used to perform a content analysis task, such as identifying and processing the screen content of the acquired shoot frame (the first shoot frame) to obtain corresponding content information.

It should be noted that in the related art, all of the shoot frames are usually sent directly to the recording unit for recording during the shooting process, but in embodiments of the present disclosure, the specified shoot frame is sent to the recording unit and the content analysis unit at the same time to simultaneously perform the recording task and the content analysis task. The specified shoot frame is the first shoot frame mentioned above, which may be each shoot frame during the recording process, or part of the shoot frames obtained by shooting (such as the shoot frames extracted at an interval), and the content analysis unit only needs to analyze the content of the first shoot frame, and the first shoot frame may be selected in different ways, which may result in different effects. For example, if the first shoot frame is each shoot frame obtained during the shooting process, the content analysis unit analyzes each shoot frame, and the final analysis result obtained is more comprehensive, and the reliability and accuracy of the content analysis can be maximally guaranteed: if the first shoot frame is a shoot frame extracted at a specified interval during the shooting process, the computational power can be effectively saved, and it can be understood that, usually, the camera continuously shoots multiple frames in a short period of time, and the screen content will not change much in a very short period of time (e.g., 1 second, 30 milliseconds, etc.), therefore, by performing the content recognition on the frame extracted at an interval, the reliability and accuracy of content analysis can be guaranteed to a certain extent on the basis of saving the computational power, thus effectively improving the analysis efficiency. In the practical application, the setting of the first shoot frame can be flexibly selected according to the demand. In addition, in the case where the first shoot frame is not every shoot frame obtained during the shooting process, there is also a second shoot frame during the shooting process, and the second shoot frame is a shoot frame that does not participate in the content analysis, so it is only necessary to send the second shoot frame to the recording unit to participate in the video recording, and it is not necessary to send the second shoot frame to the content analysis unit.

Step S204, performing a recording processing on the first shoot frames by the recording unit to obtain a recorded video; and performing a content analysis processing on the first shoot frames by the content analysis unit to obtain content analysis results of the first shoot frames.

For the specific implementation of the recording processing, reference can be made to the related art, and will not be repeated here. The embodiments of the present disclosure focus on elaborating and explaining the content analysis processing. In some embodiments, the content analysis result includes the content information of the first shoot frame, and the content analysis unit performs a recognition processing on the screen content of the first shoot frame to obtain the content information of the first shoot frame. For example, an object detection algorithm/object recognition algorithm or the like may be used to identify object information contained in the screen content, and the object information may be used as the content information. In some specific embodiments, the content information includes a type of a shot object, and the shot object is the object contained in the screen content of the first shoot frame. In the practical application, types can be divided into coarse-grained categories such as a person, an animal, a landscape, a still life, and the like, and each major category can also be further divided into a plurality of subcategories in different ways. Taking persons as an example, the persons can be divided into subcategories such as young children, adolescents, middle-aged people, elderly people, and the like according to their age stage, and the persons can be divided into subcategories such as male and female according to their gender. Age stage and gender can also be combined, and an exemplary combination includes middle-aged women, young boys, and other subcategories. Taking animals as an example, the animals can be divided into cats, dogs, birds, and the like. In addition, each kind of animals can also be further divided according to breed. Taking landscapes as an example, the landscapes can be further divided into sky, lawns, fountains, mountains, rivers, and the like. All of the above are simple examples, and should not be regarded as limitations on the present disclosure. It can be understood that each screen content may comprise a plurality of shot objects, and the content information may include the category of each shot object: in addition, the content information may further include the position or occupies size of each shot object in the shoot frame image, which is not limited herein.

Because the first shoot frame is distributed to the recording unit and the content analysis unit at the same time, the recording processing and the content analysis processing are parallel processing processes, and the embodiments of the present disclosure can obtain the content analysis result more quickly compared with the method of first performing the recording processing and then performing the content analysis processing.

Step S206, in case of obtaining the recorded video, determining a content analysis result of the recorded video based on the content analysis results of the first shoot frames: the content analysis result of the recorded video is used to perform an edit processing on the recorded video.

In the case where the first shoot frame is each of the shoot frames obtained during the shooting process, the recorded video is composed based on all first shoot frames, and in the case where the first shoot frames are the shoot frames extracted at a specified interval during the shooting process, the recorded video includes all first shoot frames and also includes the second shoot frame, the second shoot frame is a video frame image which is not used in the content analysis processing. In the case of obtaining the recorded video, the content analysis result of the recorded video may be further determined based on the content analysis results of the first shoot frames, and the content analysis result of the recorded video includes, but is not limited to, the type of the shot subject of the recorded video. For example, the content analysis results of respective first shoot frames are counted to determine the type of the shot subject of the recorded video. The type of the shot subject is the type of a shot object that mainly appears in the recorded video, such as a child, a vehicle, a landscape, and the like.

The content analysis result of the recorded video can be used for perform the edit processing on the recorded video, such as, searching for the corresponding video clip template according to the content analysis result of the recorded video, so as to automatically edit the recorded video and provide the users with a clip effect that match the recorded video, which better enhances the convenience and interest of video clipping.

The above method can directly perform recording and content analysis on the shoot frame at the same time during the shooting process, that is, the shooting process and the content analysis process are in parallel, so that the content analysis result can be obtained faster, the efficiency of editing the recorded video based on the content analysis result can be further improved. This not only effectively shortens the waiting time before the user watches the edited video, but also simplifies the overall process without requiring the user to perform complicated operations, thus comprehensively improving the user experience.

In some embodiments, the first shoot frame may be distributed to the recording unit and the content analysis unit during the shooting process when a specified condition is met. The specified condition is the condition that requires performing the content analysis on the recorded video. In some specific embodiments, the specified condition includes: a specified control on the shooting interface being triggered. The shooting interface is the interface displayed by the electronic device after the user invokes the shooting function, and the user can see a preview screen in the interface and decide how to shoot based on the preview screen. In some specific embodiments, the specified control may be a one-click video-making button for instructing the electronic device (specifically, the video clipping software installed on the electronic device) to automatically edit the recorded video without the need for the user to edit the video himself. In other words, the specified control triggers the video clipping software to provide a one-click video-making function. The specified control can be set directly on the shooting interface to make it convenient for the user to quickly and easily enable the one-click video-making function while shooting. If the specified condition is not met, for example, it is not monitored that the specified control is triggered, all the shoot frames are provided to the recording unit during the shooting process, and the content analysis is no longer performed, so as to save equipment resources.

In practical application, in order to improve the efficiency and reliability of the content analysis processing, when the content analysis processing is performed on the first shoot frame by the content analysis unit, the content analysis unit may input the first shoot frame to a content recognition model, which is preset, to perform a recognition processing on a screen content of the first shoot frame by the content recognition model. The content recognition model may be a pre-trained neural network model with a content recognition function, and after inputting the first shoot frame into the content recognition model, the content recognition model may output a result of identifying the type of the shot object contained in the first shoot frame, and may also identify a specific position of the shot object in the image. The embodiments of the present disclosure do not limit the specific implementation of the content recognition model, which may be an overall model capable of directly recognizing different types of the shot object, such as a person, an animal, a landscape, and the like, or may also be a plurality of branching models (such as a person recognition model, an animal recognition model, and the like), each of which individually recognizes a specified type, so that the specific implementation of the content recognition model can be flexibly set according to the actual situation.

In order that the content analysis result of the recorded video can be determined accurately and reliably, the step of determining the content analysis result of the recorded video based on the content analysis results of the first shoot frames may be performed with reference to the following steps A˜B:

Step A, performing statistics based on the content analysis result of each first shoot frame to determine the type of the shot subject of the recorded video.

Normally, the user has a shot subject when shooting, and the type of the shot subject can also be understood as the type of the main shot object in the video, such as a certain person, a certain landscape, and the like. On the basis that the content analysis result of the first shoot frame includes the type of the shot subject, the above step A may be implemented based on the following steps A1 and A2:

Step A1, counting a frequency of appearance of a shot object of each specified type in all of the first shoot frames.

By performing content analysis on each first shoot frame, the types of respective shot objects contained in each first shoot frame can be obtained, and then the frequency each type of shot object appearing in all the first shoot frames can be counted, for example, if the user shoots a video of 1000 frames, in which a child appears 1000 times (that is, the child appears in every frame), with an appearance frequency of the child being 100%: a puppy appears 800 times, with an appearance frequency of the puppy being 80%: a fountain appears 100 times, with an appearance frequency of the fountain being 10%: a lawn appears 100 times, with an appearance frequency of the lawn being 10%, a slide appears 200 times, with an appearance frequency of the slide being 20%, and the like. The above is only an exemplary explanation.

Step A2, determining the type of the shot subject of the recorded video based on the frequency of appearance of the shot object of each specified type.

In some embodiments, the type of the shot object with the highest frequency of appearance may be used as the type of the shot subject of the recorded video, for example, the child in the above example may be used as the type of the shot subject of the recorded video, confirming that the recorded video is a video that mainly shoots children. It is also possible to jointly take the types of the shot objects whose frequencies of appearance are ranked in the top N % as the type of the shot subject of the recorded video, N may be set according to the demand. For example, if N is 30, the types of the shot objects whose frequencies of appearance are ranked in the top 30% are selected as the type of the shot subject of the recorded video. Assuming that the shot objects whose frequencies of appearance are ranked in the top 30% in the above example are the child and the puppy, the child and the puppy in the above example are taken as the shot subject of the recorded video together, and it is confirmed that the recorded video is a video that mainly shoots children playing with dogs.

Step B, obtaining the content analysis result of the recorded video based on the type of the shot subject of the recorded video. In some embodiments, the content analysis result of the recorded video includes the type of the shot subject of the recorded video, and in addition, the content analysis result of the recorded video may also include other specific information of the shot subject, for example, including behavioral information of the shot subject, and the like, which is not limited herein.

By determining the type of the shot subject of the recorded video based on the frequency of appearance of the shot object mentioned above, the content analysis result of the recorded video can be obtained, which is not only convenient to achieve, but also makes the content analysis result of the recorded video more objective and accurate.

Further, in case of obtaining the content analysis result of the recorded video, the embodiments of the present disclosure may automatically edit the recorded video based on the content analysis result of the recorded video, and directly present a video with a specific effect for the user, so as to make the video more compelling. Specifically, it may be performed with reference to the following steps a and b:

Step a, obtaining a matching clip template of the recorded video based on the content analysis result of the recorded video.

In the practical application, the video clipping software can store various clip templates in the cloud in advance, different clip templates correspond to different styles, and can be used to match different types of shot subjects. For example, most of the matching clip templates corresponding to videos in which the type of the shot subject is a child are in a cute and lively style, and the background music and text used in the matching clip templates are more cheerful and interesting. In some embodiments, a matching clip template for the recorded video may be selected from a plurality of clip templates, and a matching similarity between the matching clip template and the recorded video is higher than a preset similarity threshold. For example, the matching similarity is based on the style of the clip template, the style of the recorded video (determined based on the type of the shot subject), the number of image frames that can be edited by the clip template, and the number of frames of the recorded video.

Step b, performing the edit processing on the recorded video through the matching clip template to obtain a target video.

In some embodiments, the clip template includes a sequence of clipping operations, the sequence of the clipping operations includes at least one clipping operation arranged in a sequential order of operation, and the target video can be obtained by clipping the recorded video according to the sequence of the clipping operations corresponding to the matching clip template. Through the above method, the user can be directly provided with the target video that best matches the actual content of the recorded video without the need for the user to clip the recorded video. Because the target video is generated based on the clip template, it is not only convenient and quick, but also the appeal is usually strong, and the clipping effect is rich and colorful, which can effectively enhance the user experience.

Further, in order to allow the user to more flexibly and freely select the clip template desired by the user according to their demand, embodiments of the present disclosure may also display template identifiers of a plurality of candidate clip templates together with the target video on a display page, perform the edit processing on the recorded video through the target clip template to obtain a formulated video in response to monitoring that a user selects a template identifier of a target clip template from the template identifiers of the plurality of candidate clip templates, and replace the target video on the display page with the formulated video.

In the above method, the template identifier of the candidate clip template may be, such as the template name and/or the template cover reflecting the template style, and the like. If the user is not satisfied with the target video automatically recommended by the video clipping software or if the user also wants to try to use other templates to clip the recorded video, the user can directly select the desired target clip template from the plurality of candidate clip templates. The video clipping software can edit and process the recorded video according to the target clip template selected by the user to obtain the formulated video for the user, and display the formulated video for the user on the display page to facilitate the user to intuitively view the clipping effect of the target clip template. In summary, embodiments of the present disclosure may directly provide the user with a target video clipped using a recommended matching clip template for the user to quickly, conveniently, and directly use; and can also select the plurality of candidate clip templates that can be selected by the user for the user to facilitate flexible selection according to the user, and ultimately to generate and display a formulated video that is most in line with the user's demand.

In embodiments of the present disclosure, the recorded video may be saved by default, and/or the target video may be saved upon receiving a save instruction issued by the user for the target video. For example, when the user shoots a video, the recorded video may be saved to an album or a user-specified folder by default, retaining the most original recorded video for the user to use by the user later. Because the target video is automatically generated by the video clipping software, it is necessary to save the target video after receiving the user's save instruction. In the actual application, the user can choose to save the target video directly, or replace the target video with a formulated video generated using other clip templates, and save the formulated video. The user can also exit the display page, and does not save the target video.

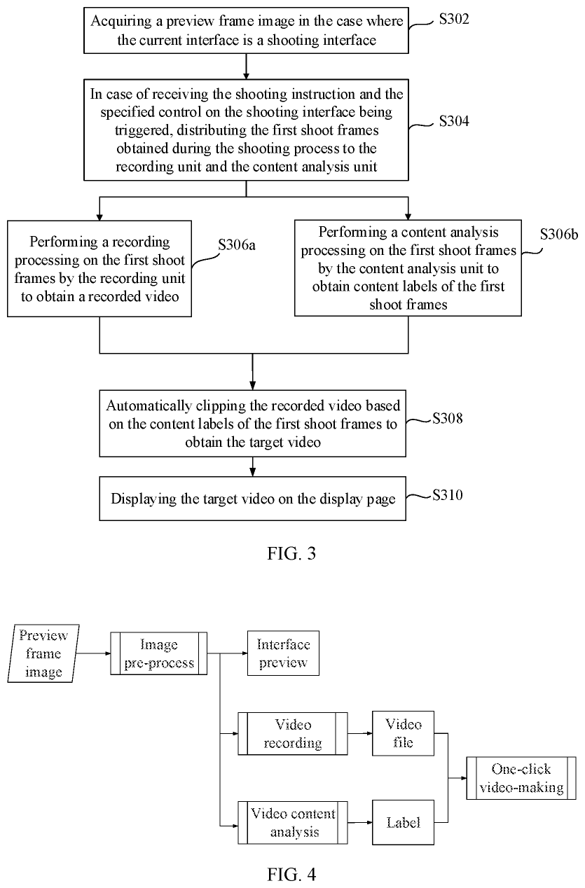

On the basis of the foregoing, for ease of understanding, taking a video shot by a user through a device such as a mobile phone as an example, embodiments of the present disclosure provide a schematic flowchart of a method for video processing as illustrated in FIG. 3, which briefly illustrates the following core steps S302˜S310.

Step S302: acquiring a preview frame image in the case where the current interface is a shooting interface.

The shooting interface is the interface displayed by the electronic device after the user invokes the shooting function, and the user can see a preview screen in the interface and decide how to shoot based on the preview screen. Usually, the shooting interface is also provided with a shooting button, and before the shooting button is triggered, the camera of the electronic device will capture the preview frame image in real time and display the preview frame image on the shooting interface in real time. The preview frame images captured in real time constitute a preview video stream, so it can also be understood that before the shooting button is triggered, the electronic device presents the preview video stream to the user in real time through the shooting interface.

Step S304: in case of receiving the shooting instruction and the specified control on the shooting interface being triggered, distributing the first shoot frames obtained during the shooting process to the recording unit and the content analysis unit. In the practical application, the specified control may be provided directly on the shooting interface, and the specified control may be, for example, a trigger button for the one-click video-making function, so that the user can directly trigger the one-click video-making function when shooting. In the practical application, if a shooting instruction is received to start shooting, the captured preview frame image can be used directly as a shoot frame, and the above first shoot frame may be each shoot frame or a shoot frame extracted at a specified interval.

Step S306a: performing a recording processing on the first shoot frames by the recording unit to obtain a recorded video.

Step S306b: performing a content analysis processing on the first shoot frames by the content analysis unit to obtain content labels of the first shoot frames. Specifically, the content label is used to label the content information of the first shoot frame.

The above step S306b and step S306a are parallel processing steps, which may be referred to in the aforementioned related content, and will not be repeated herein.

Step S308: automatically clipping the recorded video based on the content labels of the first shoot frames to obtain the target video.

In the practical application, the content labels of all of the first shoot frames can be counted to obtain the type of the shot subject of the recorded video, and then the matching clip template of the recorded video is searched based on the type of the shot subject, and the recorded video is clipped using the matching clip template.

Step S310: displaying the target video on the display page. That is, the clipped video can be automatically presented for the user.

In summary, the above method allows the shooting process and the content analysis process to be performed together in parallel, and the content analysis can be performed directly without the need to decode and then analyze the target video obtained from shooting, which comprehensively shortens the time consumed when automatically clipping the video, and shortens the waiting time before the user watches the target video.

On the basis of FIG. 3, embodiments of the present disclosure further provide a schematic diagram of a video processing flow as illustrated in FIG. 4, which briefly illustrates three parallel branches after obtaining the preview frame image: interface preview; video recording, and video content analysis. Finally, a video file obtained from video recording (i.e., the recorded video) and the label obtained from the content analysis (equivalent to the abovementioned content information) may be simultaneously input into a one-click video-making module to generate the target video finally. The video recording and video content analysis in FIG. 4 can refer to the related content mentioned above. In addition, the interface preview illustrated in FIG. 4 refers to presenting the preview screen to the user on the shooting interface, and an image processing algorithm may be used to pre-process the preview frame image before the interface preview; the pre-processed preview frame image is displayed on the shooting interface, and the image processing algorithm may be determined according to the user's function settings. For example, if the user turns on the beautification function, the image processing algorithm is the beautification algorithm; if the user sets the required filter, the image processing algorithm is the filter processing algorithm. The above are only examples, and are limited here. The one-click video-making module can find the best clip template that matches the video file based on the tag, and use the found best clip template to edit the video file to obtain the target video. Afterwards, the user can save the target video, or change the clip template to generate the desired formulated video according to the demand.

In summary; the method for video processing provided by embodiments of the present disclosure can be better applied to the one-click video-making function and improve the efficiency of one-click video-making. Specifically, the shooting process and the one-click video-making process can be processed together in parallel, and the shooting interface can be provided with a specified control (one-click video-making button), so that when the user needs the one-click video-making function, the button on the shooting interface can be triggered directly. The device can directly perform the one-click video-making based on the shoot frames without the need for the user to first store the recorded video obtained by shooting in an album and then select the recorded video from the album for the one-click video-making, thus it is very convenient and fast. When the specified control is triggered, the content information of the shoot frame can be obtained during the shooting process, so that after the shooting is completed, the target video can be quickly generated based on the content information and the recorded video, thus effectively shortening the time required for one-click video-making, simplifying the implementation process of the one-click video-making function (also known as shortening the implementation path of the one-click video-making function), and quickly improving the efficiency of one-click video-making. The user can also see the target video faster, which effectively shortens the user's waiting time and improves the user's interaction experience.

In addition, the embodiments of the present disclosure can directly perform content analysis on the shoot frame image during the shooting process, without the need for the user to first store the recorded video obtained by shooting in the album, and then select the recorded video from the album for one-click video-making. Because the recorded videos stored in the album are all processed by encoding and the like, it also solves the problem that after selecting the recorded video from the album, the recorded video needs to be decoded before content analysis can be performed. That is, the embodiment of the present disclosure can directly omit the additional decoding operation, and further shorten the time consumed by the one-click video-making.

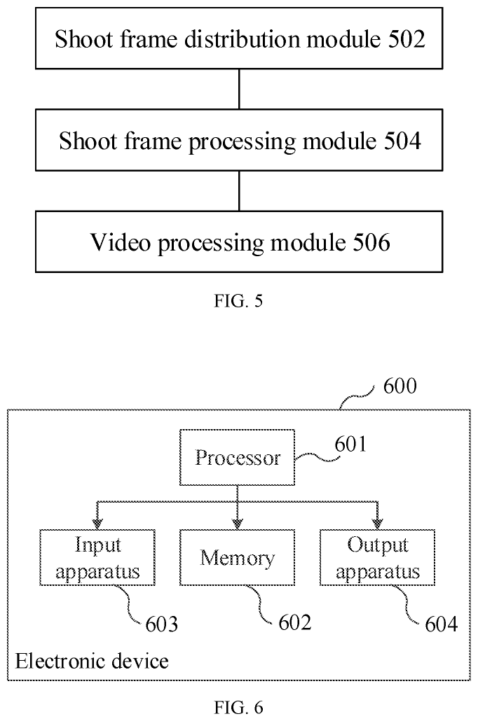

Corresponding to the aforementioned method for video processing, FIG. 5 is a structural schematic diagram of an apparatus for video processing provided by an embodiment of the present disclosure, the apparatus may be implemented by software and/or hardware, and generally may be integrated in an electronic device, as shown in FIG. 5, the apparatus comprises:
a shoot frame distribution module 502 configured to distribute first shoot frames to a recording unit and a content analysis unit during a shooting process;
a shoot frame processing module 504 configured to perform a recording processing on the first shoot frames by the recording unit to obtain a recorded video; and perform a content analysis processing on the first shoot frames by the content analysis unit to obtain content analysis results of the first shoot frames;
a video processing module 506 configured to determine a content analysis result of the recorded video based on the content analysis results of the first shoot frames in case of obtaining the recorded video, the content analysis result of the recorded video is used to perform an edit processing on the recorded video.

The above apparatus can directly perform recording and content analysis on the shoot frame at the same time during the shooting process, that is, the shooting process and the content analysis process are in parallel, so that the content analysis result can be obtained faster, the efficiency of editing the recorded video based on the content analysis result can be further improved. This not only effectively shortens the waiting time before the user watches the edited video, but also simplifies the overall process without requiring the user to perform complicated operations, thus comprehensively improving the user experience.

In some embodiments, the shoot frame distribution module 502 is used to distribute the first shoot frames to the recording unit and the content analysis unit during the shooting process in case of reaching a specified condition.

In some embodiments, the specified condition includes: a specified control on a shooting interface being triggered.

In some embodiments, the shoot frame processing module 504 is specifically used to input the first shoot frames to a content recognition model, which is preset, to perform a recognition processing on screen contents of the first shoot frames by the content recognition model.

In some embodiments, the video processing module 506 is specifically used to perform statistics based on the content analysis result of each of the first shoot frames to determine a type of a shot subject of the recorded video; and obtain the content analysis result of the recorded video based on the type of the shot subject of the recorded video.

In some embodiments, the video processing module 506 is specifically used to count the frequency of appearance of a shot object of each specified type in all of the first shoot frames; and determine the type of the shot subject of the recorded video based on the frequency of appearance of the shot object of each specified type.

In some embodiments, the first shoot frame is each shoot frame obtained during the shooting process, or the first shoot frame is a shoot frame extracted at a specified interval during the shooting process.

In some embodiments, the recorded video further includes a second shoot frame, the second shoot frame is a video frame image which is not involved in the content analysis processing.

In some embodiments, the apparatus further includes: a target video acquisition module used to obtain a matching clip template of the recorded video based on the content analysis result of the recorded video; and perform the edit processing on the recorded video through the matching clip template to obtain a target video.

In some embodiments, the apparatus further includes: a video replacement module used to display template identifiers of a plurality of candidate clip templates together with the target video on a display page: perform the edit processing on the recorded video through the target clip template to obtain a formulated video in response to monitoring that a user selects a template identifier of a target clip template from the template identifiers of the plurality of candidate clip templates: replace the target video on the display page with the formulated video.

In some embodiments, the apparatus further includes: a save module used to save the recorded video by default, and/or, save the target video upon receiving a save instruction issued by the user for the target video.

The apparatus for video processing provided by the embodiments of the present disclosure may execute the method for video processing provided by any embodiment of the present disclosure, and has the corresponding functional module for executing the method and beneficial effects.

Those skilled in the art can clearly understand that, for the convenience and brevity of the description, the specific working process of the above-described apparatus embodiments can refer to the corresponding process in the method embodiments, and will not be repeated herein.

Embodiments of the present disclosure provide an electronic device, and the electronic device includes: a processor; a memory used to store an executable instruction that can be executed by the processor; the processor is used to read the executable instruction from the memory and execute the executable instruction to implement the above method for video processing.

FIG. 6 is a structural schematic diagram of an electronic device provided by an embodiment of the present disclosure. As illustrated in FIG. 6, the electronic device 600 includes one or more processors 601 and a memory 602.

The processor 601 may be a central processing unit (CPU) or other form of processing unit having data processing capability and/or instruction execution capability, and may control other components in the electronic device 600 to perform the desired function.

The memory 602 may include one or more computer program products, the computer program product may include various forms of computer readable storage media, such as a volatile memory and/or a non-volatile memory. The volatile memory may include, for example, a random-access memory (RAM) and/or a cache memory, and the like. The non-volatile memory may include, for example, a read-only memory (ROM), a hard disk, a flash memory, and the like. One or more computer program instructions may be stored on the computer-readable storage medium, and the processor 601 may run the program instructions to implement the method for video processing provided by embodiments of the present disclosure described above and/or other desired functions. Various contents, such as an input signal, a signal component, a noise component, and the like, may also be stored in the computer-readable storage medium.

In an example, the electronic device 600 may further include: an input apparatus 603 and an output apparatus 604, these components being interconnected through a bus system and/or other forms of connection mechanisms (not shown).

In addition, the input apparatus 603 may include, for example, a keyboard, a mouse, and the like.

The output apparatus 604 may output various information to the outside, including determined distance information, direction information, and the like. The output apparatus 604 may include, for example, a display, a speaker, a printer, and a communication network and its connected remote output device, and the like.

Of course, for simplicity; only some of the components in the electronic device 600 related to the present disclosure are illustrated in FIG. 6, and components such as the bus, the input/output interface, and the like are omitted. In addition, the electronic device 600 may further include any other appropriate components, depending on the specific application.

In addition to the method and device described above, embodiments of the present disclosure may also provide a computer program product including a computer program, the computer program upon execution by a processor, causes the processor to execute the method for video processing provided by embodiments of the present disclosure.

The computer program product may be written with program code for performing the operation of embodiments of the present disclosure in any combination of one or more programming languages, the programming languages comprise object-oriented programming languages, such as Java, C++, and the like, and conventional procedural programming languages, such as C language, or similar programming languages. The program code may be executed entirely on the user's computing device, partially on the user's device, executed as a stand-alone software package, partially on the user's computing device and partially on a remote computing device, or entirely on a remote computing device or a server.

Additionally, embodiments of the present disclosure may also provide a computer-readable storage medium, on which a computer program instruction is stored, the computer program instruction upon being run by a processor causes the processor to perform the method for video processing provided by embodiments of the present disclosure.

The computer-readable storage medium may adopt any combination of one or more readable media. The readable medium may be a readable signal medium or a readable storage medium. The readable storage medium may include, for example, but is not limited to, a system, an apparatus, or a device which is electrical, magnetic, optical, electromagnetic, infrared, or semiconducting, or any combination of the above. More specific examples (a non-exhaustive list) of the readable storage medium include: an electrical connection with one or more wires, a portable disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

It should be noted that, in the present disclosure, the relational terms such as “first”, “second”, and the like, are only used to distinguish one entity or operation from another entity or operation, and are not intended to require or imply the existence of any actual relationship or order between these entities or operations. Furthermore, the terms “comprise/comprising”, “include/including”, or any other variations thereof are intended to cover a non-exclusive inclusion such that a process, method, article, or device that includes a list of elements includes not only those elements, but also other elements not expressly listed, or elements inherent to the process, method, article, or device. Without further limitation, an element limited by the statement “comprises/includes a . . . ” does not exclude the presence of additional identical elements in the process, method, article, or device that includes the element.

What have been described above are only specific implementations of the present disclosure, enabling those skilled in the art to understand or implement the present disclosure. Various modifications to these embodiments are apparent to those skilled in the art, and the generic principles defined herein may be implemented in other embodiments without departing from the spirit or scope of the present disclosure. Therefore, the present disclosure is not to be limited to the embodiments described herein but is intended to be accorded the widest scope consistent with the principles and novel features disclosed herein.

1. A method for video processing, comprising:
distributing first shoot frames to a recording unit and a content analysis unit during a shooting process;
performing a recording processing on the first shoot frames by the recording unit to obtain a recorded video; and performing a content analysis processing on the first shoot frames by the content analysis unit to obtain content analysis results of the first shoot frames;
in case of obtaining the recorded video, determining a content analysis result of the recorded video based on the content analysis results of the first shoot frames, wherein the content analysis result of the recorded video is used when performing an edit processing on the recorded video.

2. The method for video processing according to claim 1,
wherein the distributing first shoot frames to a recording unit and a content analysis unit during a shooting process comprises:
in case of meeting a specified condition, distributing the first shoot frames to the recording unit and the content analysis unit during the shooting process.

3. The method for video processing according to claim 2, wherein the specified condition comprises: a specified control on a shooting interface being triggered.

4. The method for video processing according to claim 1, wherein the performing a content analysis processing on the first shoot frames comprises:
inputting the first shoot frames to a content recognition model, which is preset, to perform a recognition processing on screen contents of the first shoot frames by the content recognition model.

5. The method for video processing according to claim 1, wherein the determining a content analysis result of the recorded video based on the content analysis results of the first shoot frames comprises:
performing statistics based on the content analysis results of the first shoot frames to determine a type of a shot subject in the recorded video;
obtaining the content analysis result of the recorded video based on the type of the shot subject in the recorded video.

6. The method for video processing according to claim 5, wherein the performing statistics based on the content analysis results of the first shoot frames to determine a type of a shot subject in the recorded video comprises:
counting a frequency of appearance of a shot object of each specified type in all of the first shoot frames;
determining the type of the shot subject in the recorded video based on the frequency of appearance of the shot object of each specified type.

7. The method for video processing according to claim 1, wherein the first shoot frames comprise each of all shoot frames obtained during the shooting process, or the first shoot frames are shoot frames extracted at a specified interval during the shooting process.

8. The method for video processing according to claim 1, wherein the recorded video further comprises a second shoot frame, the second shoot frame is a video frame image which is not used in the content analysis processing.

9. The method for video processing according to claim 1, further comprising:
obtaining a matching clip template of the recorded video based on the content analysis result of the recorded video;
performing the edit processing on the recorded video through the matching clip template to obtain a target video.

10. The method for video processing according to claim 9, further comprising:
displaying template identifiers of a plurality of candidate clip templates together with the target video on a display page;
in response to monitoring that a user selects a template identifier of a target clip template from the template identifiers of the plurality of candidate clip templates, performing the edit processing on the recorded video through the target clip template to obtain a formulated video;
replacing the target video on the display page with the formulated video.

11. The method for video processing according to claim 9, further comprising:
saving the recorded video by default, and/or, saving the target video upon receiving a save instruction issued by the user for the target video.

12. An apparatus for video processing, comprising:
a shoot frame distribution module, configured to distribute first shoot frames to a recording unit and a content analysis unit during a shooting process;
a shoot frame processing module, configured to perform a recording processing on the first shoot frames by the recording unit to obtain a recorded video; and perform a content analysis processing on the first shoot frames by the content analysis unit to obtain content analysis results of the first shoot frames;
a video processing module, configured to determine a content analysis result of the recorded video based on the content analysis results of the first shoot frames in case of obtaining the recorded video, wherein the content analysis result of the recorded video is used when performing an edit processing on the recorded video.

13. An electronic device, comprising:
a processor;
a memory used to store an executable instruction, wherein
the processor is configured to read the executable instruction from the memory and executes the executable instruction to implement a method for video processing,
wherein the method for video processing comprises:
distributing first shoot frames to a recording unit and a content analysis unit during a shooting process;
performing a recording processing on the first shoot frames by the recording unit to obtain a recorded video; and performing a content analysis processing on the first shoot frames by the content analysis unit to obtain content analysis results of the first shoot frames;
in case of obtaining the recorded video, determining a content analysis result of the recorded video based on the content analysis results of the first shoot frames, wherein the content analysis result of the recorded video is used when performing an edit processing on the recorded video.

14. A computer-readable storage medium storing a computer program, wherein the computer program is used to perform the method for video processing according to claim 1.

15. (canceled)

16. The method for video processing according to claim 2, wherein the performing a content analysis processing on the first shoot frames comprises:
inputting the first shoot frames to a content recognition model, which is preset, to perform a recognition processing on screen contents of the first shoot frames by the content recognition model.

17. The method for video processing according to claim 2, wherein the determining a content analysis result of the recorded video based on the content analysis results of the first shoot frames comprises:
performing statistics based on the content analysis results of the first shoot frames to determine a type of a shot subject in the recorded video;
obtaining the content analysis result of the recorded video based on the type of the shot subject in the recorded video.

18. The method for video processing according to claim 2, further comprising:
obtaining a matching clip template of the recorded video based on the content analysis result of the recorded video;
performing the edit processing on the recorded video through the matching clip template to obtain a target video.

19. The method for video processing according to claim 18, further comprising:
displaying template identifiers of a plurality of candidate clip templates together with the target video on a display page;
in response to monitoring that a user selects a template identifier of a target clip template from the template identifiers of the plurality of candidate clip templates, performing the edit processing on the recorded video through the target clip template to obtain a formulated video;
replacing the target video on the display page with the formulated video.

20. The method for video processing according to claim 4, further comprising:
obtaining a matching clip template of the recorded video based on the content analysis result of the recorded video;
performing the edit processing on the recorded video through the matching clip template to obtain a target video.

21. The method for video processing according to claim 10, further comprising:
saving the recorded video by default, and/or, saving the target video upon receiving a save instruction issued by the user for the target video.
